(19) United States
(12) Patent Application Publication
(10) Pub. No.: US 2001/0011022 A1
(43) Pub. Date: Aug. 2, 2001

(54) Method for controlling a diversity of multi-carrier CDMA systems in cellular environments

(76) Inventor: Jin Hee Han, City of Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/770,959

(22) Filed: Jan. 25, 2001

(30) Foreign Application Priority Data
Jan. 28, 2000 (KR) 2000-4113

(51) Int. Cl. H04Q 7/20

(52) U.S. Cl. 455/522; 455/422

(57) ABSTRACT

The present invention relates to a cellular mobile communication system, and more particularly to a diversity control method for controlling forward link power of multi-carrier CDMA (Code Division Multiple Access) system in cellular environments.

A method for controlling a frequency diversity of multi-carrier CDMA systems in cellular environments according to the present invention, comprises controlling the number of carriers in a forward and a reverse links according to a strength of a signal and a distance between a base-station and a mobile terminal.

The diversity control method complementarily uses frequency diversity control method for controlling the number of the carriers according to the distance between the base-station and the mobile terminal and power control method for controlling transmission power according to the distance. Preferably, a power control method for controlling a transmission power according to said distance can be complementarily used in a region using the same number of carriers. It is also preferred that additional carriers can be allocated from an adjacent base-station in the case of high transmission rate of base-station signal or poor signal state.

### TECHNICAL FIELD

The present invention relates to a cellular mobile communication system, and more particularly, to a diversity control method for controlling forward link power of multi-carrier CDMA (Code Division Multiple Access) system in cellular environments.

### BACKGROUND OF THE INVENTION

Multi-carrier CDMA method is preferred as next generation cellular mobile communication method providing frequency diversity or higher data rate in comparison with the conventional single-carrier CDMA method.

Applying this multi-carrier method to cellular environments, according as the number of multi-carriers is increased, pseudo orthogonal code or pseudo noise code would be used due to the limitation of the number of orthogonal codes which can be allocated in the forward link of a cell.

Even though the orthogonal code is used, there is some multi-path interference. Therefore, the forward link power control greatly influences the performance of the system.

For the precise power control, the power of a transmitter must be adaptively controlled according to cellular environment. Therefore, transmission amplifier with wide dynamic range is required. And in the case of incapable of doing precise power control, the performance is degraded by multi-user, multi-path and/or inter-cell interference signals.

FIG. 1 is a graph illustrating a necessary forward link transmission power according to a position of mobile terminal to acquire maximum performance (which minimizes the probability of bit error) in the case of using the multi-carrier CDMA method with the conventional general power control scheme in cellular environments.

As above described, the performance of CDMA communication system is determined by the strength of an interference signal. Therefore, the performance of the system can be improved by reducing the strength of interference signals.

For doing so, when a mobile terminal is placed close to a base-station in the forward link, by lowering transmission power the transmitted signal from the base-station to the mobile terminal reduces the influence of interference signals to other users in the same cell or other cells Herein, due to radio wave characteristics that the receiving power of the mobile terminal is in inverse proportion to the power of two or four of the distance between the base-station and the mobile terminal, there is considerably large power difference between the mobile terminal with short distance and that with long distance from the base-station.

The base-station should use a transmission amplifier with wide dynamic range to accommodate all mobile terminals in the long and short distance, and because the implementation of an effective linear amplifier is difficult, the high cost is inevitable.

And, when bit errors occur at the power control bits, it would increase interference to other user signals.

Summarizing the above descriptions, in the case of applying the multi-carrier CDMA method to cellular environments, the conventional power control method requires high complexity in implementation, and also wide linear dynamic range of transmission amplifiers. Therefore, this causes problems of high cost in the implementation of a mobile terminal and base-station and high power consumption.

### SUMMARY OF THE INVENTION

The embodiments of the present invention provides the diversity control method capable of acquiring performance corresponding to that of the conventional power control method, while fixing the power of the transmitter or greatly reducing dynamic range of that transmitter through either the substitution or complementation of the conventional power control by effectively distributing the source of diversity, which multi-carrier system has.

A method for controlling a frequency diversity of multi-carrier CDMA systems in cellular environments according to the present invention, comprises controlling the number of carriers in a forward and a reverse links according to a strength of a signal and a distance between a base-station and a mobile terminal.

Preferably, a power control method for controlling a transmission power according to said distance can be complementarily used in a region using the same number of carriers.

It is preferred that additional carriers can be allocated from an adjacent base-station in the case of high transmission rate of base-station signal or poor signal state.

### BRIEF DESCRIPTION OF THE DRAWINGS

The embodiments of the present invention will be explained with reference to the accompanying drawings, in which:

FIG. 1 is a graph illustrating an optimal forward link power in the case of power control in general multi-carrier CDMA systems.

FIG. 2 and FIG. 3 show diversity allocation methods of multi-carrier CDMA systems in cellular environments according to the embodiments of the present invention.

FIG. 4 is a graph illustrating an optimal forward link power in the case of diversity control in multi-carrier CDMA systems according to the present invention.

FIG. 5 is a graph comparing the conventional power control method with the diversity control method of the present invention.

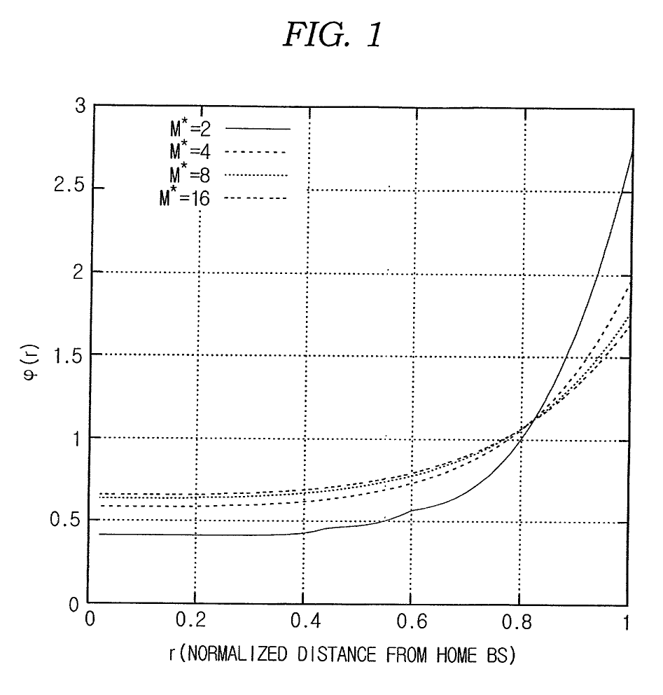

### DETAILED DESCRIPTION OF THE INVENTION

Multi-carrier CDMA system is simultaneously transmitting system thorough several carriers using a wide bandwidth.

In multi-carrier system, according as the number of carriers is increased, the degree of acquiring diversity is increased and the performance is improved. Therefore, the degree of diversity is utilized as an important source in the multi-carrier system.

The power control is that distributing low power to a mobile user in short distance from a base-station and on the contrary, distributing high power to a mobile user in long distance from the base-station. However, because the multi-carrier system has a source of frequency diversity instead of a source of power, the diversity control method can be used for either substituting or complementing the power control method in cellular environments.

The present invention is for providing the diversity control method capable of acquiring performance corresponding to that of the conventional power control method, while fixing the power of the transmitter or greatly reducing dynamic range of that transmitter through either the substitution or complementation of the conventional power control by effectively distributing the source of diversity, which multi-carrier system has.

The followings give detailed explanation of method for controlling a diversity of multi-carrier CDMA systems in cellular environments according to the embodiments of the present invention by referring to accompanying drawings.

The present invention provides two methods for diversity control.

The first is pure diversity control (DC) method that distributes the number of carriers (M) out of the number of total multi-carriers (M*) according to the distance between the base-station and the mobile terminal, while the output power of each carrier being fixed.

By using these diversity methods, the dynamic range of the transmitter is fixed, therefore, the implementation of the transmitter is much easier in comparison with the conventional power control (PC) method.

Needless to say, comparing with the ideal power control method assuming that there is no continuous change of power level and errors, due to the discontinuous number of multi-carriers being selected and the limitation of the values (1 through M*), the performance is somewhat degraded.

However, the conventional power control method practically controls the output power discontinuously, is influenced by the non-linear characteristics of an amplifier, and produces large interference signals in the case of errors' occurrence. By these reasons, the practical performance of the conventional power control method is greatly degraded.

On the contrary, the diversity control method is much simpler in implementation and has advantages of being much smaller influence of interference signals by the control error in comparison with the power control method.

The second is power and diversity control (PDC) method that uses the diversity control method together with the power control method.

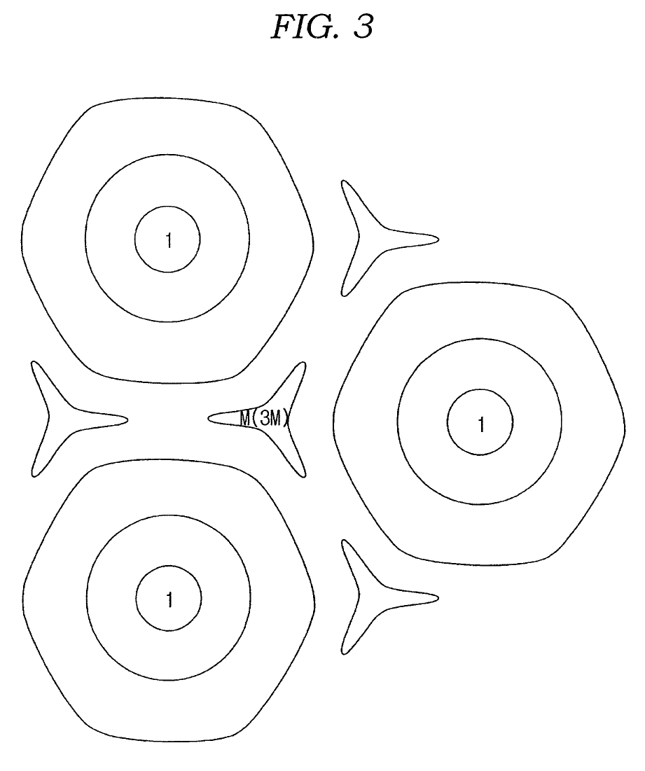

Although this method controls the number of transmission carriers through the same method as the diversity control method as shown in FIG. 3, the method uses the power control method according to the distance variation complementarily in the region using the same number of carriers.

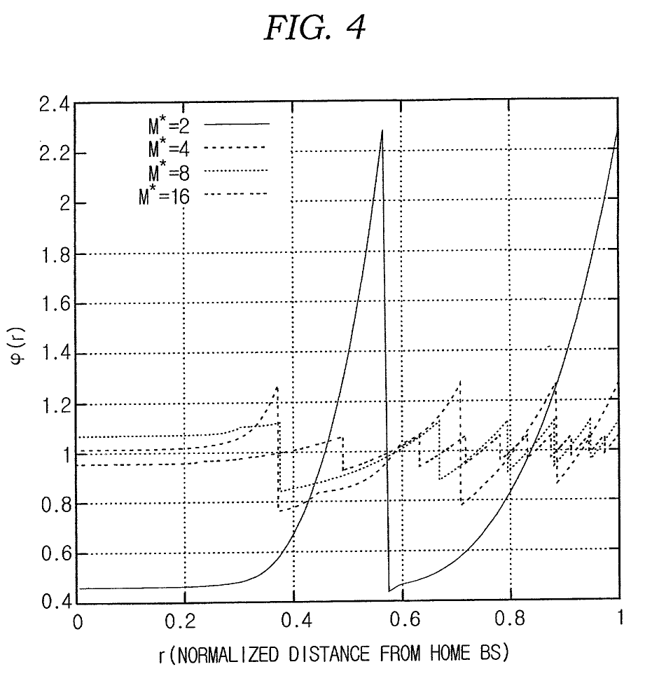

FIG. 4 illustrates the necessary transmission power in the case of using the power and diversity control method. As shown in FIG. 4, according as the number of carriers (M*) capable of being transmitted is increased, the dynamic range of transmission power is abruptly decreased and it is known that the variation of the output power is in the range of 10 percent from the case of M* being 16.

Although, the power and diversity control method uses two control methods complementarily, due to the same status information such as measurement of power, which is necessary in the system using the pure power control method, the system complexity is not nearly increased in comparison with the system using the power control method.

As described above, by using the power and diversity control method, the performance is improved in comparison with the first method, and the dynamic range of the transmission amplifier is greatly reduced in comparison with the case of using the power control method.

Assuming that the maximum number of carriers used by one base-station is M*, in the case of the mobile terminal with the longest distance from the base-station, the maximum number of M* is used out of the number of carriers (1 through M*). Moreover, when the signal transmission rate from the base-station is high or signal is suffered from fading, additional carriers are allocated from an adjacent base-station.

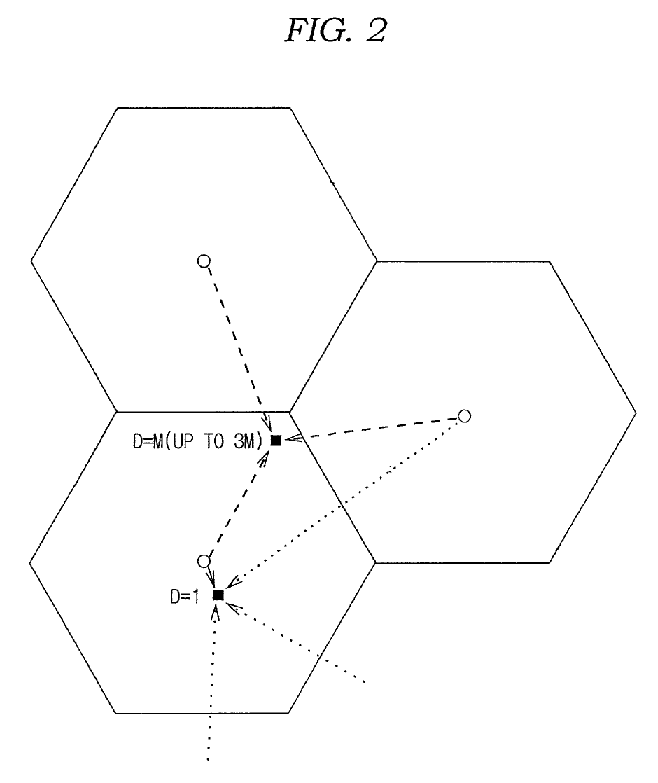

As shown in FIG. 2 and FIG. 3, in the case of hexagon cells, the number of carriers can be increased maximally to the triple (3M*) and the performance can be improved.

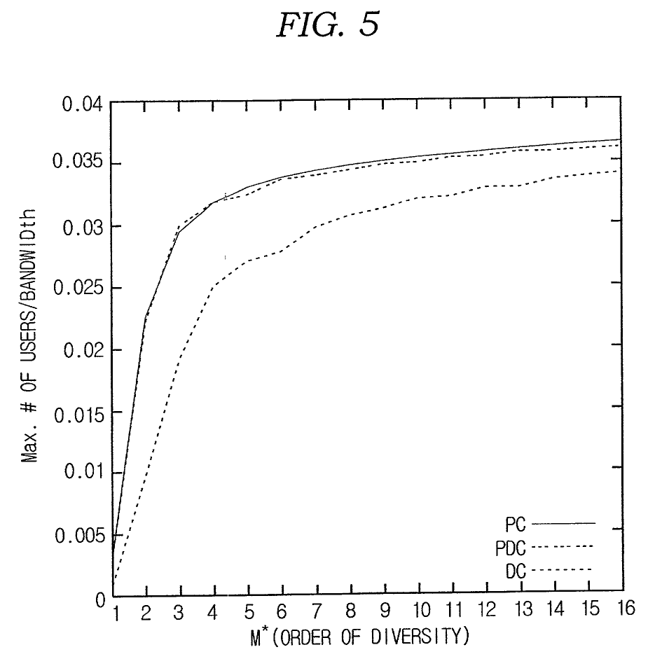

FIG. 5 is a graph comparing the performance of the conventional power control method with that of the diversity control method of the present invention. It can be known that the power control method and the power and diversity control method show nearly the same performance and although the performance of the diversity control method is somewhat degraded, the width is decreased according as the number of multi-carriers (M*).

On the basis of these results, the power and diversity control method can be applied to the system with smaller number of multi-carriers and the diversity control method can be applied to the system with more multi-carriers.

Doing so, the performance corresponding to that of the conventional power control method, while the power of the transmitter being fixed or dynamic range of that transmitter being greatly reduced, can be acquired and the influence of control error can be reduced.

Although, the present invention was described by applicable examples, these examples are not intended to limit the present invention. Also, it will be appreciated by those skilled in the art that changes and variations in the embodiments herein can be made without departing from the spirit and scope of the present invention as defined by the following claims.

What we claim:

1. A method for controlling a frequency diversity of multi-carrier CDMA systems in cellular environments, which comprises controlling the number of carriers in a forward and a reverse links according to a strength of a signal and a distance between a base-station and a mobile terminal.

2. The method of claim 1, wherein a power control method for controlling a transmission power according to said distance is complementarily used in a region using the same number of carriers.

3. The method of claim 2, wherein additional carriers are allocated from an adjacent base-station in the case of high transmission rate of base-station signal or poor signal state.
